(19) United States
(12) Patent Application Publication
(10) Pub. No.: US 2025/0001946 A1
(43) Pub. Date: Jan. 2, 2025

(54) UNIVERSAL USE CAR SEAT GAP FILLER

(71) Applicant: Siqing Xu, Shenzhen (CN)

(72) Inventor: Siqing Xu, Shenzhen (CN)

(21) Appl. No.: 18/655,225

(22) Filed: May 4, 2024

(30) Foreign Application Priority Data
Mar. 30, 2024 (US) 29935228
Apr. 25, 2024 (CN) 2024105022477

(51) Int. Cl. B60R 7/08; B60N 3/10

(52) U.S. Cl. CPC B60R 7/08; B60N 3/102

(57) ABSTRACT

A universal use car seat gap filler, including a main structure, an adjustable base, an adjustable partition baffle, a layered cover plate, and an adjustable function expansion rack; the adjustable base has plurality long strip holes passed through by one entire elastic band forming plurality divided rooms to be filled with small EVA paddings; the main structure has connection port to connect function expansion rack which is mounted with foldable cup holder. The layered cover plate divides the left chamber of main structure into two layers; the adjustable partition baffle divides the right chamber of main structure into different size storing rooms.

### CROSS-REFERENCES

This application is based upon and claims the benefit of priority from U.S. Pat. No. D1,011,261 S and China Patent No. CN308543218S, CN308543219S, CN308045659S and China application No. 2024105022477, filed on 25 Apr. 2024, U.S. application Ser. No. 29/935,228, filed on 30 Mar. 2024

### REFERENCE TO RELATED PATENTS

U.S. Pat. No. D1,011,261 S and China Patent No. CN308543218S, CN308543219S, CN308045659S.

### BACKGROUND OF THE INVENTION

The present invention relates to the technical field of a car seat gap filler, and more specifically relates to a universal use ca seat gap filler.

The car seat gap filler not only prevents items from falling into the gaps of the car seat between the consoles, but also has storage functions.

A prior art, most of these devices have an integrated structure, includes the upper part being the main body which is divided into zones for storing items, the lower structure as the seat gap-filling part, most car seat gap fillers' designs own a shape of a cup holder to facilitate the placement of water cups by users, however, this structure makes the entire product very wide, even reaching about 75 mm, which greatly occupies the seat space.

Most Car seat gap fillers have fixed thickness or use compressible sponges to fill the gap, none of which can adapt to the ever-changing irregular gaps of car seats, This makes the users face six awkward situations, 1) The filling device is too thick and cannot be installed; 2) The gap filling device of the storage box is too thin or too soft, and the installation is not stable, causing the car seat gap filler to shake during vehicle driving; 3) As mentioned above, the car seat gap filler is too wide and takes up seat space; 4) after placing the water cup, the car seat gap fillers tilt forward due to weight gain; 5) small objects and pointed objects cannot be stored safely, may be bumped out, posing safety hazards during the driving; 6) most car seat gap fillers actually have all the items mixed together, retrieving items with difficult.

Therefore, a need exists for adjustable thickness of car seat gap filler that allow user to adjust to fit the gap of his/her car perfectly, to place their water bottles without occupying seat positions, to store small things safely, to know where the items are placed.

### SUMMARY OF THE INVENTION

The present invention aims to provide a universal car seat gap filler that can be well adjusted and applied regardless of the ever-changing width of gap between seat gaps and car consoles, meanwhile, a function extension rack has been added to facilitate the placement of foldable cup holder.

In order to achieve the above objects, the present invention adopts the following solutions:

A car seat gap filler comprises a main structure, an adjustable partition baffle, a layered cover plate, an adjustable base, and an adjustable function expansion rack.

The adjustable partition baffle is connected to wall slots of main structure through its seven inserts to form different size storing rooms, the user can reconnect after rotating the adjustable partition baffle 180 degrees, forming a symmetrical pattern of partitions comparing with rotation before, suitable for user habits, two curved anti-collision sponges attached to the wall of the partitioned room to prevent the stored item from shaking left and right while the car is in motion.

The main structure comprises a connection port connecting an adjustable function expansion rack mounted with a foldable cup holder, replacing the normal design of placing cups inside of car seat gap filler, greatly reducing the width, and avoiding seat occupancy.

The main structure comprises a layered cover plate in the left chamber installed by a rotating shaft at the left end, dividing the left chamber into two layers: upper and lower, the layered cover plate can be locked by its handle crossbeam pressing against the grooves on the adjustable partition baffle, and can be easy opened or closed with little force.

The upper left end of the main structure comprises a pair of different sizes of clips connecting to the clip container below, suitable for storing of different thicknesses or a certain length items.

The main structure is connected to the adjustable base below by slide rails, reconnecting the slide rails in different direction can make the universal use car seat gap filler face differently, meeting the different requirements of left and right seat personnel, the users can independently adjust it by themselves.

The base comprises a single layer board with plurality long strip holes, bending transitionally towards the centerline of the slide rail reducing the occupation of space below the seat gap, avoiding insertion difficulties caused by the slope angle of console in the vertical direction, in this embodiment, the long strip holes is fourteen including two serrated holes at both ends of the base, the elastic band passes through the long strip holes forming five divided areas, the both ends of elastic band is clamped by the serrated holes, the users can stretch the entire elastic band to adjust the each divided area thickness to fill the space by provided EVA (ethylene vinyl acetate copolymer) paddings according to each divided area's gap width.

The adjustable function expansion rack comprises two insert boards, a frame and screw holes, choosing different insert board to connect the main structure can adjust the orientation of foldable cup holder mounted on the frame.

### BRIEF DESCRIPTION OF DRAWINGS

FIG. 1 is the main structure schematic diagram of the three dimensional of a preferred embodiment of the present invention.

FIG. 2 is the base schematic diagram of the three dimensional of a preferred embodiment of the present invention

FIG. 3 is the adjustable partition baffle schematic diagram of the three dimensional of a preferred embodiment of the present invention.

FIG. 4 is the layered cover plate schematic diagram of the three dimensional of a preferred embodiment of the present invention

FIG. 5 is the function expansion rack schematic diagram with two insert boards of the three dimensional of a preferred embodiment of the present invention

FIG. 6 is a section view schematic diagram of the three dimensional of a preferred embodiment of the present invention

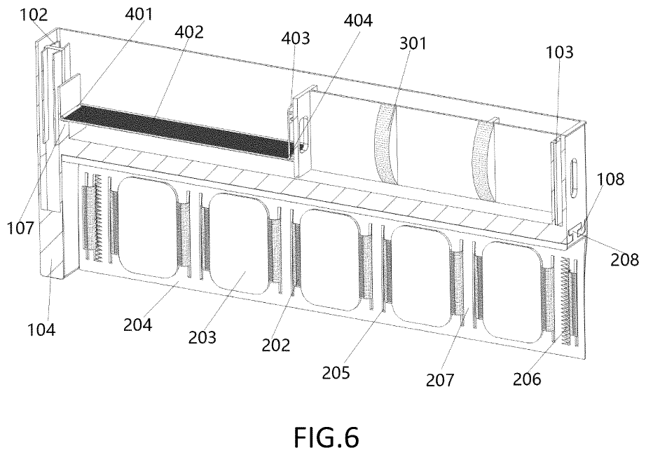

FIG. 7 shows the front view of single layer board with fourteen long strip holes structure of a preferred embodiment of the present invention.

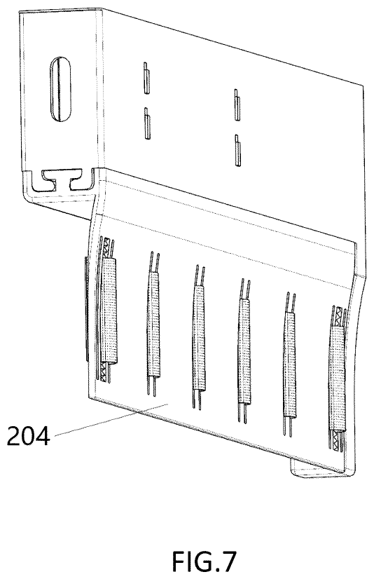

FIG. 8 is the EVA (ethylene vinyl acetate copolymer) paddings accessory of a preferred embodiment of the present invention.

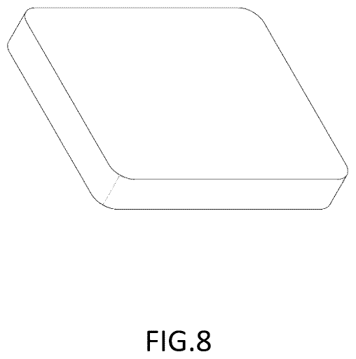

FIG. 9 is the opening status diagram of layered cover plate of a preferred embodiment of the present invention.

FIG. 10 is the status diagram for the user in the right seat, with a foldable cup holder, a preferred embodiment of the present invention

FIG. 11 is the status diagram for the left seat user of a preferred embodiment of the present invention.

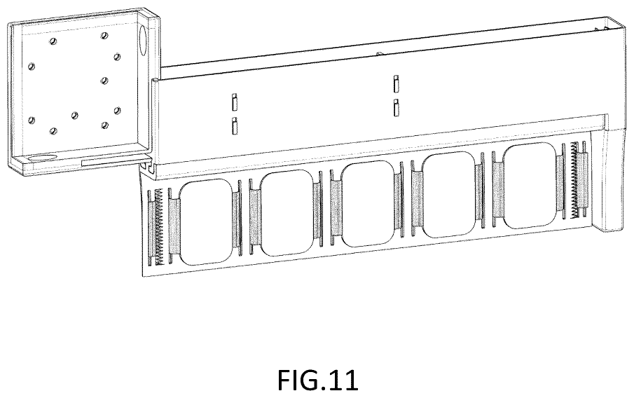

### DETAILED DESCRIPTION OF THE INVENTION

In order to further explain the technical solutions of the present invention, the present invention will be explained in detail by the specific embodiments.

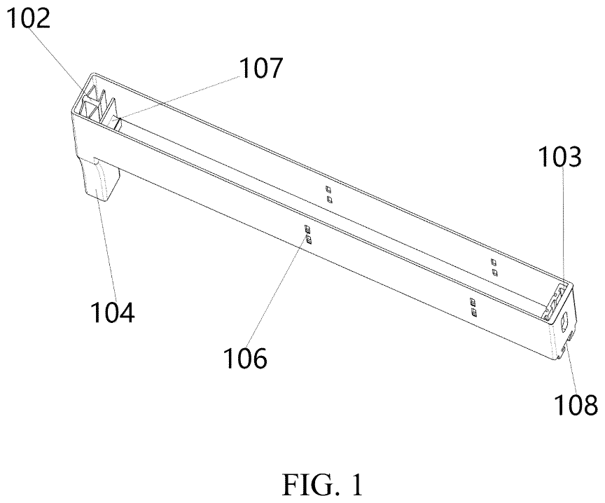

Referring to FIG. 1, the main structure 1 comprises a pair of clips 102 and clip container 104 at the left side, a rotating shaft is installed on the left side of chamber, a connection port 103 is at the right end for connecting the function expansion rack 5, at the bottom of the main structure 1 is slide rail 108 for connecting the base 2, six slots 106 are on the right chamber walls.

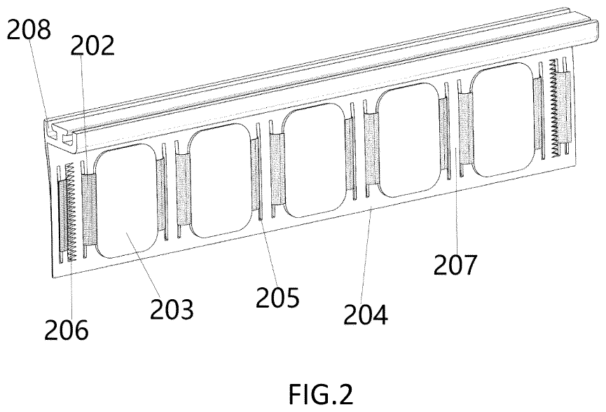

Referring to FIG. 2, a base 2 with single layer board 204 comprises a slide rail 208, fourteen long strip holes 205 including two serrated strip holes 206 passed through by one entire elastic band 202 forming five divided areas 203.

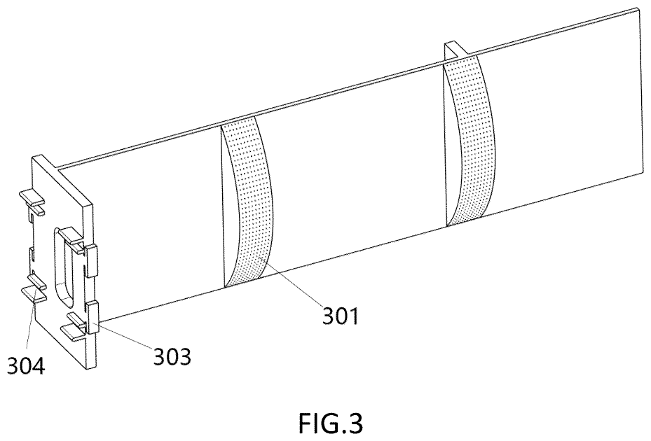

Referring to FIG. 3, an adjustable partition baffle 3 comprises two curved anti-collision sponges 301, six inserts 303 for connecting adjustable partition baffle with main structure 1, two grooves 304 on top and bottom respectively for crossbeam 403 to be pressed against.

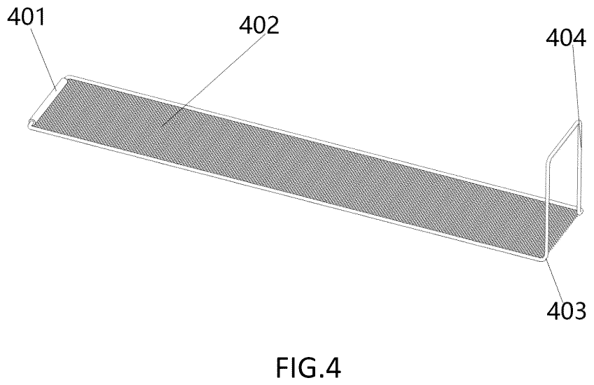

Referring to FIG. 4, a layered cover plate 4 comprises a rotating shaft 401 on the left end, a handle 404 on the right, crossbeam 403, main plate 402, dividing the left chamber into two layers, lifting the handle to open, pressing down the handle to lock.

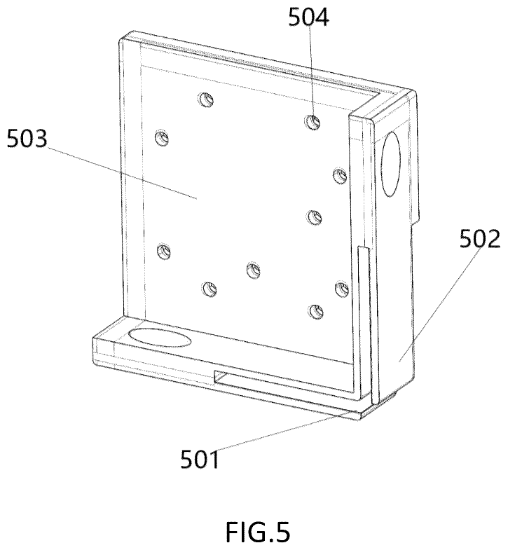

Referring to FIG. 5, a function expansion rack 5 comprises two insert boards 501, 502 for connecting the main structure's connection port 103, rack frame 503 and rack screw holes 504 for mounting foldable cup holder.

In this embodiment, the user connects the adjustable partition baffle 3 into main structure 1, forming a storing room with different sizes, if the user does not like this partition, just to rotate 180 degrees and reinstall again, as the angle of the insert 303 is 10 degrees in the vertical inward direction, and the angle of the slot 106 inclination surface in the vertical inward direction is also 10 degrees, after the insert matching the slot, a 10 degree angle in the vertical direction will be maintained, creating a resistance that prevents the insert from being easily pulled out unless a certain amount of force is applied, the room with two curved anti-collision sponges 301 is used for storing mobile phone.

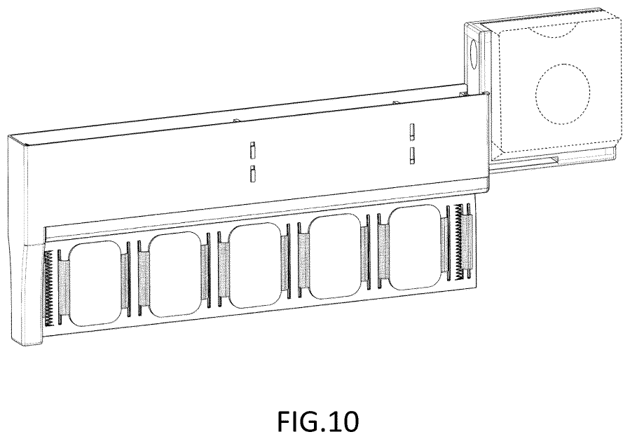

FIG. 10 shows the state view 9 when the universal use car seat gap filler is installed at the right seat position, If the user in the left seat wants to use, just slide the base 2 out from main structure 1, changing direction and reconnect, both ends of the main structure rail 108 comprises two convex points with a diameter of 2 millimeters, Corresponding to it, two 2.2 mm concave points are located at both ends of the base slide rail 208, after the concave convex fitting, the slide rail 108 and the slide rail 208 are not easy to slip off, but can be slided open when separated by force and relative sliding.

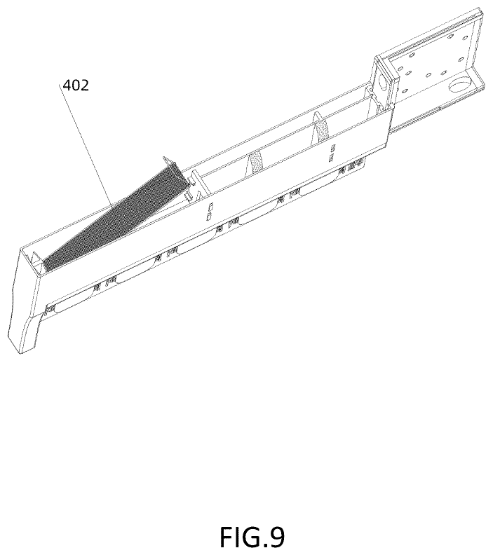

FIG. 9 is the opening status diagram of the layered cover plate, the user can store small items, valuable items, or pointed items in the lower layer, after covering it, glasses can be placed on the upper layer, due to adopting elastic cloth material of the layered cover plate, needn't to worry about damaging the glasses

A pair of clips 102 can keep the user's sharp items with the tip facing downwards to protect the user from injury; most users store the pen for writing records during the journey.

For a car seat gap filler, the most important thing is whether its thickness is suitable for the user car's gap and whether it can be loaded firmly, in this embodiment of the present invention, one complete elastic band 202 fixed at both ends by serrated hole 206 passes through the fourteen long strip holes 205 on the single layer board 204 forming five divided areas 203, that is to say, the overall unevenness of the gap width between the seat and the console is divided into five relatively uniform and adjustable room areas, due to the use of a length of 345 mm elastic band with an elongation rate of 300%, the total length of the elastic band 202 after extension will be 1035 mm, therefore, the users can stretch the elastic band 202 to a large extent according to the car seat gap, making rooms bigger to fill with EVA paddings 8 of the different thickness of 4 mm, 6 mm and 8 mm.

The present disclosure is not limited to the above embodiment and may be changed as appropriate without departing from the scope. For example, using multiple small boards instead of one complete single layer board 204 will be considered same design; creating new shapes of connection port at the right end of the main structure 1 to achieve new function extensions is also considered same design; layered cover plate 4 using different rotating shaft will be one device.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A universal use car seat gap filler, comprising:
A main structure with slide rail;
An adjustable base with slide rail comprises: a single layer board with plurality long strip holes, wherein one entire elastic band passing through, forming plurality divided areas to be filled by small EVA paddings;
An adjustable function expansion rack mounted by foldable cup holder, connected to the main structure implementing function expansion;
An adjustable partition baffle connected with the walls of right chamber of main structure forming storage rooms of different sizes;
A layered cover plate installed onto the main structure by a rotating shaft, dividing the left side chamber into upper and lower layers;
A pair of clips with container.

2. The universal use car seat gap filler of claim 1, wherein the slide rail of the main structure is connected with slide rail of the base or reconnected by changing direction according to needs to form different orientation of the universal use car seat gap filler.

3. The universal use car seat gap filler of claim 1, wherein the function expansion rack comprising two insert boards to choose, connecting different insert board to the main structure's connection port can form different orientation of the function expansion rack, making the convenient use for personnel on the left and right seats.

4. The universal use car seat gap filler of claim 3, wherein the function expansion rack comprising one frame and screw holes to be mounted by foldable cup holder which can be closed when not in use to reduce legroom occupancy.

5. The universal use car seat gap filler of claim 1, wherein the base below comprising one single layer board bending transitionally towards the centerline of the slide rail, reducing the occupation of space below the seat gap, meanwhile, avoiding insertion difficulties caused by the slope angle of console in the vertical direction.

6. The universal use car seat gap filler of claim 1, wherein the single layer board comprises plurality long strip holes passed through by one entire elastic band, forming plurality-divided areas, the two ends of elastic band are clamped by the serrated holes on both ends of the single layer board.

7. The universal use car seat gap filler of claim 6, wherein the plurality-divided areas on the single layer board wrapped with elastic band can be stretched and enlarged to fill by provided EVA paddings one by one.

8. The universal use car seat gap filler of claim 1, wherein the upper left of main structure comprising two clips connecting a container below for storing pointed items.

9. The universal use car seat gap filler of claim 1, wherein on the left side of the chamber of the main structure, the layered cover plate is installed by a rotating shaft, and dividing the left chamber into upper and lower layers, the crossbeam of the handle on the right end of layered cover plate presses against the groove of partition baffle to lock the layered cover plate.

10. The universal use car seat gap filler of claim 1, wherein the main structure is connected with an adjustable partition baffle, which can be reconnected after rotating 180 degrees by user themselves to form a symmetrical pattern compared with rotation before, providing convenience for different personnel of left and right seats.

11. The adjustable partition baffle comprises a pair of anti-collision sponges, used to protect user items from shaking left and right during vehicle driving.
